(19) United States
(12) Patent Application Publication
(10) Pub. No.: US 2013/0099156 A1
(43) Pub. Date: Apr. 25, 2013

(54) USE OF LIQUID COMPOSITIONS COMPRISING IMIDAZOLIUM SALTS AS OPERATING MATERIALS

(71) Applicants: Christoph STOCK, Ellerstadt (DE); Dirk Gerhard, Mannheim (DE)

(72) Inventors: Christoph STOCK, Ellerstadt (DE); Dirk Gerhard, Mannheim (DE)

(21) Appl. No.: 13/658,019

(22) Filed: Oct. 23, 2012

Related U.S. Application Data
(60) Provisional application No. 61/550,932, filed on Oct. 25, 2011.

(51) Int. Cl. C09K 5/00; C09D 5/00; C10M 133/46; C09K 3/00

(52) U.S. Cl. 252/78.1; 252/182.12; 252/182.3; 252/77; 106/287.21; 508/269

(57) ABSTRACT

Use of a composition comprising

a) at least one imidazolium salt of the formula I

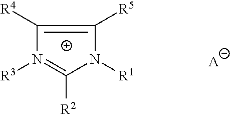

where R¹ and R³ are each, independently of one another, an organic radical having from 1 to 20 carbon atoms,
R², R⁴ and R⁵ are each, independently of one another, an H atom or an organic radical having up to 20 carbon atoms and
A⁻ is an anion, and
   b) at least one carboxylate selected from among those of the formula IIa

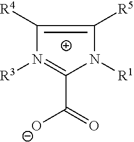

of the formula IIb

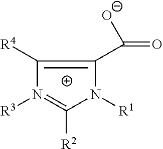

and the formula IIc

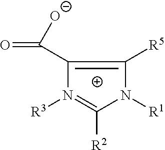

where the radicals R¹ to R⁵ are as defined above,
as operating material in industrial apparatuses.

The present application incorporates the provisional U.S. application 61/550,932 filed on Oct. 25, 2011 by reference.

The present invention relates to the use of a composition comprising

a) at least one imidazolium salt of the formula I

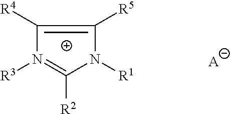

where R¹ and R³ are each, independently of one another, an organic radical having from 1 to 20 carbon atoms,
R², R⁴ and R⁵ are each, independently of one another, an H atom or an organic radical having up to 20 carbon atoms and
A⁻ is an anion, and
   b) at least one carboxylate selected from among those of the formula IIa

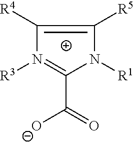

of the formula IIb

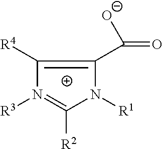

and the formula IIc

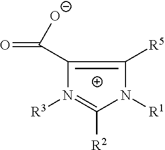

where the radicals R¹ to R⁵ are as defined above, as operating material in industrial apparatuses.

Imidazolium salts having a melting point below 100° C., in particular imidazolium salts which are liquid at room temperature, have many uses as ionic liquids. They are also becoming increasingly important as operating materials in industrial apparatuses. Thus, the use of ionic liquids as absorption medium in heat pumps is described in WO 2005/113702. Use of ionic liquids as hydraulic fluid, lubricant, barrier liquid or sealing liquid are, for example, also mentioned in WO 2006/087333.

In the abovementioned uses, suitable ionic liquids have to possess a variety of required properties. In all uses as operating material in industrial apparatuses, it is important that the operating materials cause only very little if any corrosion or decomposition on the parts of the apparatuses.

There are a number of different industrial production processes for preparing imidazolium salts. Possibilities are, for example, the Arduengo process described in WO 1991/146678 (single-stage synthesis of the salts), the alkylation of imidazole by means of an alkylating agent, anion exchange or the carbonate process described in WO 2005/021484 or WO 2009/040242. In the carbonate process, 1,3-disubstituted imidazoles are reacted with diesters of carbonic acid to form the imidazolium alkylcarbonate; other imidazolium salts can be obtained from the imidazolium alkylcarbonate by addition of an appropriate acid and the resulting elimination of CO₂. In the carbonate process, carboxylates of the formula II above can be formed as by-products, as is also indicated in WO 2009/040242.

It is an object of the present invention to provide ionic liquids or compositions based on ionic liquids which cause very little corrosion and are therefore suitable as operating materials in industrial apparatuses.

We have accordingly found the above-defined use and the above-defined compositions.

The Imidazolium Salts

The composition comprises at least one imidazolium salt of the formula I

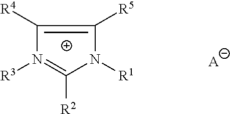

where R¹ and R³ are each, independently of one another, an organic radical having from 1 to 20 carbon atoms,

R², R⁴ and R⁵ are each, independently of one another, an H atom or an organic radical having up to 20 carbon atoms and A⁻ is an anion.

Preference is given to R1 and R3 each being, independently of one another, an organic radical having from 1 to 10 carbon atoms. The organic radical can also comprise further heteroatoms, in particular oxygen atoms, nitrogen, sulfur or phosphorus atoms, or functional groups, for example hydroxyl groups, ether groups, ester groups or carbonyl groups.

In particular, R1 and R3 are each a hydrocarbon radical which apart from carbon and hydrogen can comprise at most hydroxyl groups, ether groups, ester groups or carbonyl groups.

Particular preference is given to R1 and R3 each being, independently of one another, a hydrocarbon radical which have from 1 to 20 carbon atoms, in particular from 1 to 10 carbon atoms, and does not comprise any other heteroatoms, e.g. oxygen or nitrogen. The hydrocarbon radical can be aliphatic (including unsaturated aliphatic groups) or aromatic or comprise both aromatic and aliphatic groups. R1 and R3 are preferably each an aliphatic hydrocarbon radical.

As hydrocarbon radicals, mention may be made by way of example of the phenyl group, benzyl group, a phenyl group or benzyl group substituted by one or more C1 to C4 alkyl groups, alkyl groups and alkenyl groups, in particular the allyl group.

R1 and R3 are very particularly preferably each a C1-C10-alkyl group. As alkyl group, particular preference is given to a C1-C6-alkyl group and in a particular embodiment the alkyl group is a C1-C4-alkyl group, in particular a methyl group or an ethyl group.

Preference is given to R2, R4 and R5 each being, independently of one another, a hydrogen atom or an organic radical having from 1 to 10 carbon atoms. The organic radical can also comprise further heteroatoms, in particular oxygen atoms, nitrogen, sulfur or phosphorus atoms, or functional groups, for example hydroxyl groups, ether groups, ester groups or carbonyl groups.

In particular, R2, R4 and R5 are each a hydrogen atom or a hydrocarbon radical which apart from carbon and hydrogen can comprise at most hydroxyl groups, ether groups, ester groups or carbonyl groups.

Particular preference is given to R2, R4 and R5 each being, independently of one another, a hydrogen atom or a hydrocarbon radical which has from 1 to 20 carbon atoms, in particular from 1 to 10 carbon atoms, and does not comprise any heteroatoms (oxygen, nitrogen, etc.). The hydrocarbon radical can be aliphatic (including unsaturated aliphatic groups) or aromatic or comprise both aromatic and aliphatic groups. R2, R4 and R5 are preferably each an aliphatic hydrocarbon radical.

As hydrocarbon radicals, mention may be made by way of example of the phenyl group, benzyl group, a phenyl group or benzyl group substituted by one or more C1-C4-alkyl groups, alkyl groups and alkenyl groups, in particular the allyl group.

R2, R4 and R5 are very particularly preferably each a hydrogen atom or a C1-C10-alkyl group. As alkyl group, particular preference is given to a C1-C6-alkyl group and in a particular embodiment the alkyl group is a C1-C4-alkyl group, in particular a methyl group or an ethyl group.

In a particular embodiment, R2 is a hydrogen atom and the two radicals R4 and R5 are each a hydrogen atom or an organic radical.

Very particular preference is given to all the radicals R2, R4 and R5 each being H atoms.

The anion A⁻ in formula I can be any anion.

Possible anions are, for example, compounds having a carboxylate group (carboxylates for short). Preferred carboxylates are the anions of alkanecarboxylic acids, in particular C1-C4-alkanecarboxylic acids, preferably the acetate anion.

Further suitable anions can be selected from the following groups (polyvalent anions mentioned are the counteranions of a number of imidazolium cations corresponding to the valence):
the group of halides and halogen-comprising compounds of the formulae:
   F⁻, Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, BCl₄⁻, SbF₆⁻, AsF₆⁻, ZnCl₃⁻, SnCl₃⁻, CuCl₂⁻, CF₃SO₃⁻, (CF₃SO₃)₂N⁻, CF₃CO₂⁻, CCl₃CO₂⁻, CN⁻, SCN⁻, OCN⁻, NO²⁻, NO³⁻, N(CN)⁻;
the group of sulfates, sulfites of the general formulae:
   SO42-, HSO4⁻, SO₃²⁻, HSO₃⁻, R^{a}SO₃⁻,
the group of phosphates of the general formulae:
   PO₄³⁻, HPO₄²⁻, H₂PO₄⁻, R^{a}PO₄²⁻, HR^{a}PO₄⁻, R^{a}R^{b}PO₄⁻;
the group of phosphonates and phosphinates of the general formulae:
   R^{a}HPO₃⁻, R^{a}R^{b}PO₂⁻, R^{a}R^{b}PO₃⁻;
the group of phosphites of the general formulae:
   PO₃³⁻, HPO₃²⁻, H₂PO₃⁻, R^{a}PO₃²⁻, R^{a}HPO₃⁻, R^{a}R^{b}PO₃⁻;
the group of phosphonites and phosphinites of the general formulae:
   R^{a}R^{b}PO₂⁻, R^{a}HPO₂⁻, R^{a}R^{b}PO⁻, R^{a}HPO⁻;
the group of borates of the general formulae:
   BO₃³⁻, HBO₃²⁻, H₂BO3⁻, R^{a}R^{b}BO₃⁻, R^{a}HBO₃⁻, R^{a}BO₃²⁻, B(OR^{a})(OR^{b})(OR^{b})(OR^{d})⁻, B(HSO₄)⁻, B(R^{a}SO4)⁻;
the group of boronates of the general formulae:
   R^{a}BO₂²⁻, R^{a}R^{b}BO⁻;
the group of silicates and silicic esters of the general formulae:
   SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻;
the group of alkylsilane and arylsilane salts of the general formulae:
   R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻;
the group of carboximides, bis(sulfonyl)imides and sulfonylimides of the general formulae:

R^{a} and R^{b} and R^{c} in the above formulae are each, independently of one another, an organic radical having preferably from 1 to 20 carbon atoms, particularly preferably a hydrocarbon radical and very particularly preferably an aliphatic radical, in particular a C1-C10-alkyl group).

In a preferred embodiment, the anion A⁻ is an organic sulfonate or a mixture of organic sulfonates.

Preferred sulfonates are anions of acids of the formula III

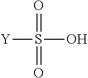

where Y is an organic radical having from 1 to 10 carbon atoms.

Y is preferably an aliphatic radical having from 1 to 10 carbon atoms, in particular a hydrocarbon radical which comprises no other heteroatoms or a hydrocarbon radical in which the H atoms can be entirely or partly replaced by fluorine.

Y is particularly preferably a C1-C4-hydrocarbon radical in which the H atoms can be entirely or partly replaced by fluorine.

Y is very particularly preferably a methyl group H₃C (anion: methylsulfonate) or an F₃C group (anion: triflate).

The imidazolium salts of the formula I preferably have a melting point (at 1 bar) of less than 200° C., in particular 100° C., particularly preferably less than 50° C. and very particularly preferably less than 30° C.; the preferred imidazolium salts of the formula I are therefore ionic liquids. In particular, the imidazolium salt of the formula I is liquid at room temperature.

In particular, the composition can comprise a plurality of different imidazolium salts of the formula I.

In a preferred embodiment, the composition comprises, as imidazolium salts,

a) an imidazolium methanesulfonate of the formula IV

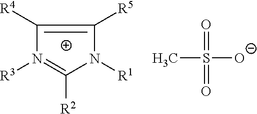

and an imidazolium triflate of the formula V

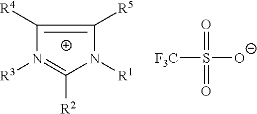

where the radicals R1 to R5 are as defined above and have the above-defined preferred meanings.

In a preferred embodiment, the composition can comprise

from 5 to 95% by weight, in particular from 20 to 80% by weight or from 30 to 70% by weight and particularly preferably from 40 to 60% by weight, of imidazolium methanesulfonate and from 5 to 95% by weight, in particular from 20 to 80% by weight or from 30 to 70% by weight and particularly preferably from 40 to 60% by weight, of imidazolium triflate,
based on the total weight of imidazolium methanesulfonate and imidazolium triflate. Particularly preferred compositions comprise imidazolium methanesulfonate and imidazolium triflate, e.g. in a weight ratio of 1:1.

In a preferred embodiment, the proportion of imidazolium salts having an anion of acids of the formula III, in particular imidazolium methanesulfonates, imidazolium triflates or mixtures thereof, is more than 50% by weight, in particular more than 80% by weight and particularly preferably more than 95% by weight, or 100% by weight, based on the total amount of all imidazolium salts in the composition.

### The Carboxylates

Apart from the imidazolium salts a), the composition necessarily comprises at least one carboxylate b) selected from among those

of the formula IIa

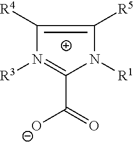

of the formula IIb

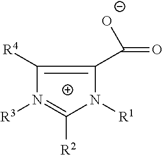

and of the formula IIc

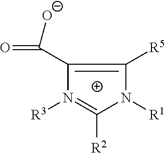

where the radicals R¹ to R⁵ are as defined above.

The radicals R1 to R5 accordingly also have all the above preferred meanings, i.e. in a very particularly preferred embodiment, R1 and R3 are each a C1-C4-alkyl group, in particular a methyl group or an ethyl group;

R2 is a hydrogen atom and the two radicals R4 and R5 are each a hydrogen atom or an organic radical; in particular, R4 and R5 are each a hydrogen atom.

The composition can, for example, comprise only a single one of the carboxylates or any mixtures of two of the three carboxylates or mixtures of all three carboxylates. In a preferred embodiment, mixtures of all three carboxylates are present.

The composition preferably comprises carboxylates of the formula II in an amount of at least 0.1 part by weight, in particular 0.5 part by weight, preferably at least 1 part by weight, per 100 parts by weight of the total amount of imidazolium salts a).

The composition preferably comprises carboxylates of the formula II in an amount of not more than 20 parts by weight, in particular not more than 10 parts by weight, preferably not more than 8 parts by weight, in particular not more than 5 parts by weight, per 100 parts by weight of the total amount of imidazolium salts a).

Suitable compositions therefore comprise, for example, carboxylates of the formula II in a total amount of, for example, from 0.1 to 20 parts by weight or from 0.2 to 10 parts by weight per 100 parts by weight of imidazolium salts of the formula I.

### Production of the Composition

The composition can be produced in a simple way by mixing the imidazolium salts a), the carboxylates b) and further constituents.

As an alternative, mixtures of the imidazolium salts a) and the carboxylates b) can be obtained directly by using the carbonate process for preparing the imidazolium salts. The carbonate process is, for example, described in WO 2005/021484 or WO 2009/040242.

In the carbonate process, 1,3-disubstituted imidazoles are reacted with diesters of carbonic acid to form the imidazolium alkylcarbonate; other imidazolium salts can be obtained from the imidazolium alkylcarbonate by addition of an appropriate acid, e.g. the above sulfonic acid of the formula III, and the resulting elimination of CO₂.

Accordingly, an imidazolium salt having a carbonate anion

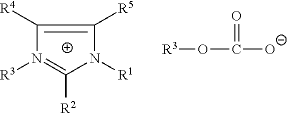

is prepared in a first process step by reacting corresponding imidazoles

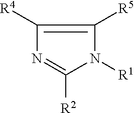

with an alkyl carbonate

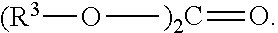

Once again, the radicals R1 to R5 have the above meanings.

The alkyl carbonate is preferably a di-C1-C4-alkyl carbonate, in particular dimethyl carbonate.

The molar ratio of the imidazole to the alkyl carbonate can be, for example, 1 mol of imidazole to from 0.5 to 2 mol of alkyl carbonate, in particular 1 mol of imidazole to from 1.2 to 1.6 mol of alkyl carbonate.

The reaction is preferably carried out at elevated pressure and temperatures.

The temperature is preferably from 50 to 200° C., particularly preferably from 80 to 200° C., very particularly preferably from 100 to 180° C.

The pressure can preferably be from 2 to 50 bar, in particular from 5 to 30 bar.

The reaction can be carried out in the presence or absence of a catalyst.

The reaction is preferably carried out in methanol.

In the second process step, an acid comprising the anion A⁻ is added to the solution. The acidity of the acid or the salt should be such that the carbonate anion in formula II (preferably the methylcarbonate anion) is decomposed into the corresponding alcohol (methanol) and carbon dioxide. The second process step, too, is preferably carried out in the presence of methanol.

The anion A of the acid then replaces the carbonate anion.

The above carboxylates are obtained as by-products in the reaction.

The less methanol used as solvent in the two stages of the reaction, the greater the total amount of carboxylates. The content of carboxylates in the product decreases with increasing amount of methanol, as is also reported in WO 2009/040242. The desired content of carboxylates can be set in this way.

The solution obtained therefore comprises the desired imidazolium salts and the carboxylates as by-products. The methanol and any other solvents used can, if desired, be removed.

Other constituents of the composition and use.

The compositions may optionally comprise, in addition to the imidazolium salts a) and carboxylates b), further additives, in particular additives which are necessary or helpful in the intended use of the composition.

These can be, for example, corrosion inhibitors, antifoams, extreme pressure additives or antiwear additives or thickeners. Extreme pressure additives prevent the welding together of 2 metallic workpieces under high pressure; antiwear additives reduce abrasion or wear in the case of high friction or load. Thickeners increase the viscosity of the composition; suitable thickeners are, for example, oligomeric or polymeric compounds.

The composition can also comprise further solvents. These can be, for example, water or nonionic organic solvents. In particular, they can be solvents which are homogeneously miscible with the ionic liquid. Mention may therefore be made of water and polar aliphatic solvents having hydroxyl groups or ether groups, in particular water and methanol, as solvents.

In a preferred embodiment, the composition comprises more than 50% by weight, in particular more than 70% by weight and particularly preferably more than 85% by weight, of the imidazolium salts a) and the carboxylates b). In particular, compositions which consist exclusively of the imidazolium salts a) and the carboxylates b) are also suitable.

The viscosity of the composition is preferably from 10 mPa*s to 2500 mPa*s at 20° C. The viscosity indicated is the dynamic viscosity.

The composition is used as operating material in industrial apparatuses. Operating materials are materials which are present in industrial apparatuses in the long term and are necessary for operation of the apparatuses or aid operation or prevent or reduce damage to the apparatuses during operation.

Operating materials are, in particular, pressure transmission media, heat transfer media, absorption media, damping materials, sealing materials or lubricants. Accordingly, the composition can be used as pressure transmission medium, heat transfer medium, absorption medium, damping material, sealing material or lubricant in industrial apparatuses. As industrial apparatuses, mention may be made by way of example of engines, e.g. piston engines, generators, pumps, compressors, blowers, gearboxes, heating apparatuses, cooling apparatuses, heat pumps or turbines.

When used as operating material, the compositions result in significantly reduced corrosion on parts of the apparatus.

### EXAMPLES

### 1) Compositions

Abbreviations used:

EMIM: 1-ethyl-3-methylimidazolium (in formula I: R1=methyl and R3=ethyl)

The following compositions were tested:
A1: EMIM methanesulfonate having a content of about 3.2 parts by weight of carboxylates of the formula II per 100 parts by weight of EMIM methanesulfonate
A2: EMIM methanesulfonate free of carboxylates of the formula II
B1: EMIM triflate having a content of about 3.2 parts by weight of carboxylates of the formula II per 100 parts by weight of EMIM triflate
B2: EMIM triflate free of carboxylates of the formula II

### Preparation of A1 and B1

These were prepared by the carbonate method as described in comparative example 1 of WO 2009/040242. For this purpose, 36.04 g of 1-ethylimidazole, 54.05 g of dimethyl carbonate and 38.61 g of methanol were stirred at 140° C. and 13 bar in an autoclave for 36 hours. After cooling, the reaction mixture comprised EMIM methylcarbonate and carboxylates of the formula II.

The resulting mixture of EMIM methylcarbonate and carboxylates was then reacted with methylsulfonic acid (to form EMIM methanesulfonate) or with trifluoromethylsulfonic acid (to form EMIM triflate).

### Preparation of the Mixtures A2 and B2 (for Comparison)

The mixtures A2 and B2 did not comprise any carboxylates.

They were not prepared by the carbonate process but by alkylation of 1-ethylimidazole with methyl methanesulfonate or methyl trifluoromethanesulfonate as alkylating agent.

### A2

97.0 g of 1-ethylimidazole and 100 ml of methanol were heated to boiling and 111.1 g of methyl methanesulfonate were then added dropwise. The consumption of the alkylation agent was monitored by means of the Preuβmann test. Altogether, another 1.5 g of 1-ethylimidazole were added. The mixture was stirred overnight under reflux. On the next day, the Preussmann test is negative and the conversion is complete. Methanol was then separated off on a rotary evaporator.

### B2

43.2 g of 1-ethylimidazole and 100 ml of methanol were placed in a reaction vessel and heated to boiling and 74.5 g of methyl trifluoromethanesulfonate were then added dropwise. The mixture was stirred overnight and on the next morning the Preuβmann test was negative; the conversion is therefore complete. Methanol was then separated off on a rotary evaporator.

The EMIM methanesulfonate and EMIM triflate obtained were free of carboxylates of the formula II.

### 2) Use Tests

Metal plates (weight of the plates about 22 gram) were stored at 90° C. in about 75 gram of the compositions A1, A2, B1 and B2 for 24 hours.

The metal plates were then taken out and the decreasing weight of the metal plates was determined. Furthermore, the content of metal ions in the composition after storage was determined; the content of metal ions in the compositions was previously less than 10 ppm.

Results are shown in the table.

| | Decreasing weight | Content of Fe ions | Content of Ni ions |
|---|---|---|---|
| Compo- | of the metal plates | in the composition | in the composition |
| sition | after storage | after storage | after storage |
| A1 | 19 milligram (mg) | 290 ppm | less than 10 ppm |
| A2 | 29 mg | 430 ppm | less than 10 ppm |
| B1 | 1 mg | less than 10 ppm | less than 10 ppm |
| B2 | 91 mg | 1100 ppm | less than 10 ppm |

1. The use of a composition comprising
a) at least one imidazolium salt of the formula I 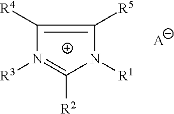
where R¹ and R³ are each, independently of one another, an organic radical having from 1 to 20 carbon atoms,
R², R⁴ and R⁵ are each, independently of one another, an H atom or an organic radical having up to 20 carbon atoms and
A⁻ is an anion, and
b) at least one carboxylate selected from among those of the formula IIa 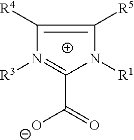
of the formula IIb 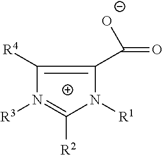
and the formula IIc 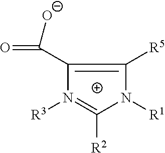
where the radicals R¹ to R⁵ are as defined above,
as operating material in industrial apparatuses.

2. The use according to claim 1, wherein the anion A⁻ is an organic sulfonate or a mixture of organic sulfonates.

3. The use according to claim 1 or 2, wherein the anion A⁻ is an anion of acids of the formula III 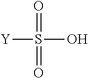
where Y is an aliphatic C1-C4-hydrocarbon radical in which the H atoms may be entirely or partly replaced by fluorine.

4. The use according to any of claims 1 to 3, wherein the imidazolium salts of the formula I are a mixture of imidazolium methanesulfonate and imidazolium triflate.

5. The use according to any of claims 1 to 4, wherein the composition comprises more than 50% by weight of imidazolium salts of the formula I.

6. The use according to any of claims 1 to 5, wherein the composition comprises from 0.1 to 20 parts by weight of carboxylates of the formula II per 100 parts by weight of imidazolium salts of the formula I.

7. The use according to any of claims 1 to 6, wherein the composition is used as pressure transmission medium, heat transfer medium, absorption medium, damping material, sealing material or lubricant in industrial apparatuses.

8. A composition comprising
a) an imidazolium methanesulfonate of the formula IV 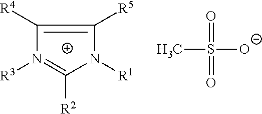
and an imidazolium triflate of the formula V 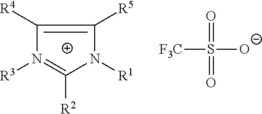
and
b) at least one carboxylate selected from among those of the formula IIa 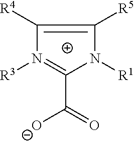
of the formula IIb 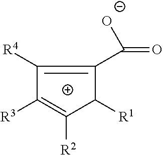
and the formula IIc 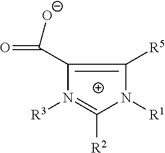
where the radicals R¹ to R⁵ are as defined above.

9. The composition according to claim 8 comprising
from 5 to 95% by weight of imidazolium methanesulfonate and
from 5 to 95% by weight of imidazolium triflate,
based on the total weight of imidazolium methanesulfonate and imidazolium triflate.
